(19) United States
(12) Patent Application Publication
(10) Pub. No.: US 2026/0281266 A1
(43) Pub. Date: Sep. 17, 2026

(54) MEDIUM DISCHARGING APPARATUS AND IMAGE READING APPARATUS

(71) Applicant: SEIKO EPSON CORPORATION, TOKYO (JP)

(72) Inventors: Seiji TEZUKA, KITAKYUSHU-SHI (JP); Masaki NAMIKI, KITAKYUSHU-SHI (JP)

(21) Appl. No.: 19/568,931

(22) Filed: Mar. 17, 2026

(30) Foreign Application Priority Data
Mar. 17, 2025 (JP) 2025-042141

(51) Int. Cl. H04N 1/00

(52) U.S. Cl. CPC H04N 1/00631; H04N 1/00591; H04N 1/00602; H04N 1/00615

(57) ABSTRACT

A medium discharging apparatus includes: a discharge roller pair configured to discharge a medium; a lever unit configured to come into contact with the medium discharged by the discharge roller pair; and a discharge tray configured to receive the medium discharged by the discharge roller pair, and the lever unit includes a stiffening lever configured to come into contact with the medium discharged by the discharge roller pair to stiffen the medium, and a suppression lever configured to come into contact with the medium at a position downstream of the stiffening lever in a direction in which the medium is discharged by the discharge roller pair to cause the medium to fall toward the discharge tray.

### CROSS REFERENCE TO RELATED APPLICATIONS

The present application is based on, and claims priority from JP Application Serial Number 2025-042141, filed Mar. 17, 2025, the disclosure of which is hereby incorporated by reference herein in its entirety.

### BACKGROUND

### Technical Field

The present disclosure relates to a medium discharging apparatus and an image reading apparatus.

### Related Art

JP-A-2015-016977 describes a medium discharging apparatus including a discharge roller pair that discharges a medium, a contact member that comes into contact with the medium discharged by the discharge roller pair, and a discharge tray that receives the medium discharged by the discharge roller pair. The contact member comes into contact with the medium to form a wave shape in the medium, that is, what is called a stiffened medium. The medium is thus appropriately discharged to the discharge tray.

JP-A-2015-016977 is an example of the related art.

In such a medium discharging apparatus, improvement in processing speed is desired. When the speed at which the discharge roller pair discharges the medium is increased, however, the medium having gained momentum is forcefully discharged and may therefore not be appropriately discharged onto the discharge tray.

### SUMMARY

A medium discharging apparatus according to an aspect of the present disclosure includes: a discharge roller pair configured to discharge a medium; a lever unit configured to come into contact with the medium discharged by the discharge roller pair; and a discharge tray configured to receive the medium discharged by the discharge roller pair, and the lever unit includes a stiffening lever configured to come into contact with the medium discharged by the discharge roller pair to stiffen the medium, and a suppression lever configured to come into contact with the medium at a position downstream of the stiffening lever in a direction in which the medium is discharged by the discharge roller pair to cause the medium to fall toward the discharge tray.

An image reading apparatus according to another aspect of the present disclosure includes a reader configured to read an image on a medium; and the medium discharging apparatus described above.

### BRIEF DESCRIPTION OF THE DRAWINGS

FIG. 1 is a diagrammatic view showing an example of an image reading apparatus including a medium discharging apparatus.

FIG. 2 is a side view of a discharge roller pair.

FIG. 3 is a front view of the discharge roller pair.

FIG. 4 is a side view of a lever unit.

FIG. 5 is a side view immediately before a tip of a medium is nipped by a discharge roller pair.

FIG. 6 is a side view after the tip of the medium is nipped by the discharge roller pair.

FIG. 7 is a side view immediately before the rear end of the medium passes through the discharge roller pair.

FIG. 8 is a side view after the rear end of the medium passes through the discharge roller pair.

### DESCRIPTION OF EMBODIMENTS

An embodiment of an image reading apparatus including a medium discharging apparatus will be described below with reference to the drawings. The image reading apparatus is, for example, a scanner that reads an image such as a character or a photograph printed on a medium such as a sheet or a film.

### Image Reading Apparatus

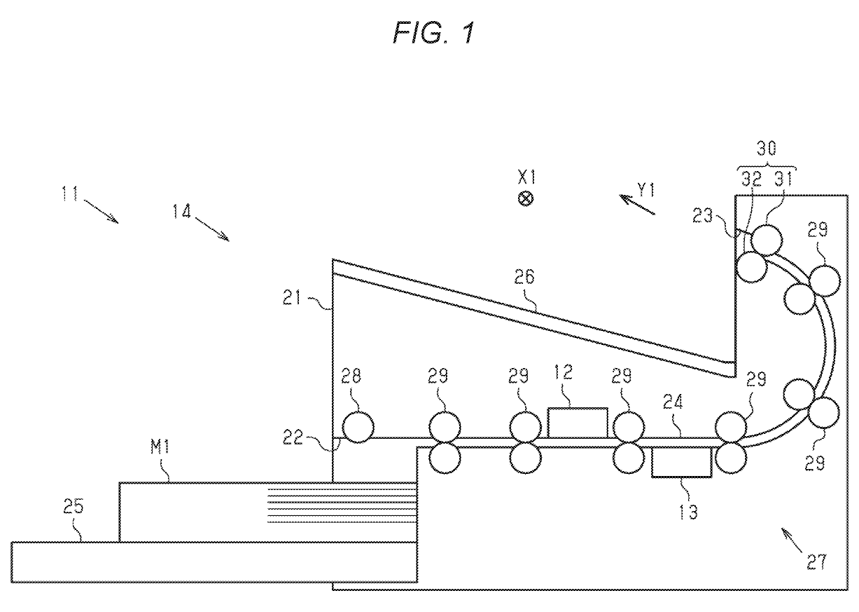

An image reading apparatus 11 includes one or more readers, as shown in FIG. 1. In an example, the image reading apparatus 11 includes a first reader 12 and a second reader 13. The readers are configured to read a medium M1. The readers each include an image sensor. The readers each include, for example, a CMOS device. The readers each irradiate the medium M1 with light and read the medium M1 by receiving the reflected light. The first reader 12 is configured to read the front surface of the medium M1. The second reader 13 is configured to read the rear surface of the medium M1. The image reading apparatus 11, which includes the multiple readers, can read opposite surfaces of the medium M1. The image reading apparatus 11 may include only one of the first reader 12 and the second reader 13.

The image reading apparatus 11 includes a medium discharging apparatus 14. The medium discharging apparatus 14 is configured to discharge the medium M1. In an example, the medium discharging apparatus 14 is configured to discharge a read medium M1.

### Medium Discharging Apparatus

The medium discharging apparatus 14 will next be described.

The medium discharging apparatus 14 includes an enclosure 21. The enclosure 21 houses various elements that constitute the medium discharging apparatus 14. The enclosure 21 houses the readers. In an example, the enclosure 21 houses the first reader 12 and the second reader 13.

The enclosure 21 is provided with a supply port 22. The supply port 22 is an opening via which the medium M1 to be supplied into the enclosure 21 passes. In an example, the medium M1 before it is read is supplied into the enclosure 21 via the supply port 22.

The enclosure 21 is provided with a discharge port 23. The discharge port 23 is an opening via which the medium M1 discharged from the interior of the enclosure 21 passes. In an example, the medium M1 after it is read is discharged from the interior of the enclosure 21 via the discharge port 23.

A conveyance path 24 is defined in the enclosure 21. The conveyance path 24 is a path along which the medium M1 is conveyed. The conveyance path 24 extends in the enclosure 21. The conveyance path 24 extends from the supply port 22 to the discharge port 23. In an example, the conveyance path 24 extends via the readers. In detail, the conveyance path 24 extends via the first reader 12 and the second reader 13. The medium M1 is therefore read by the readers in the course of the conveyance along the conveyance path 24.

The medium discharging apparatus 14 may include a supply tray 25. The supply tray 25 is so configured that the medium M1 is stacked thereon. The medium M1 to be supplied into the enclosure 21 is stacked on the supply tray 25. In an example, the medium M1 before it is read is stacked on the supply tray 25. The medium discharging apparatus 14 may include a medium cassette that houses the medium M1 before it is read in place of the supply tray 25.

The supply tray 25 is attached to the enclosure 21. The supply tray 25 extends outward from the enclosure 21. The supply tray 25 extends outward from the supply port 22 of the enclosure 21. The supply tray 25 may be configured to be lifted and lowered. The supply tray 25 may include, for example, a hopper.

The medium discharging apparatus 14 includes a discharge tray 26. The discharge tray 26 is so configured that the medium M1 is stacked. The discharge tray 26 is so configured that the medium M1 discharged from the interior of the enclosure 21 is stacked. In an example, the medium M1 after it is read is stacked on the discharge tray 26.

The discharge tray 26 is attached to the enclosure 21. In an example, the discharge tray 26 is attached to an upper portion of the enclosure 21. The discharge tray 26 may be configured to extend from the enclosure 21 in a discharge direction Y1, in detail, from the discharge port 23 in the discharge direction Y1. The discharge tray 26 receives the medium M1 falling via the discharge port 23.

The medium discharging apparatus 14 includes a conveyer 27. The conveyer 27 is attached to the enclosure 21. The conveyer 27 is configured to convey the medium M1. The conveyer 27 is configured to supply the medium M1 from the supply tray 25. The conveyer 27 is configured to convey the medium M1 along the conveyance path 24. The conveyer 27 is configured to discharge the medium M1 onto the discharge tray 26.

The conveyer 27 may include a supply roller 28. The supply roller 28 is a roller that supplies the medium M1 from the supply tray 25 into the enclosure 21. The supply roller 28 is located at the supply port 22. The supply roller 28 is located so as to come into contact with the medium M1 stacked on the supply tray 25. In an example, the supply roller 28 is located so as to come into contact with an uppermost medium M1 out of the multiple media M1 stacked on the supply tray 25. The supply roller 28 therefore supplies the media M1 with the aid of a driven motor sequentially from the uppermost medium M1 out of the multiple media M1 stacked on the supply tray 25. The supply tray 25 is lifted so that the supply roller 28 comes into contact with the medium M1. The supply roller 28 may also be configured to approach the supply tray 25.

The conveyer 27 may include one or more conveyance roller pairs 29. In an example, the conveyer 27 includes multiple conveyance roller pairs 29. The conveyance roller pairs 29 are each a roller pair that conveys the medium M1 along the conveyance path 24. The conveyance roller pairs 29 are located along the conveyance path 24. The conveyance roller pairs 29 each convey the medium M1 supplied from the supply roller 28 toward the readers with the aid of a driven motor. The conveyance roller pairs 29 convey the medium M1 read by the readers toward the discharge port 23.

The conveyer 27 includes a discharge roller pair 30. The discharge roller pair 30 is a roller pair that discharges the medium M1. In detail, the discharge roller pair 30 is a roller pair that discharges the medium M1 from the enclosure 21 toward the discharge tray 26 with the aid of a driven motor. The discharge roller pair 30 discharges the medium M1 via the discharge port 23. The discharge roller pair 30 is located at the discharge port 23. The medium M1 discharged by the discharge roller pair 30 is received by the discharge tray 26.

The discharge roller pair 30 includes two discharge rollers. In detail, the discharge roller pair 30 includes an upper discharge roller 31 and a lower discharge roller 32. The upper discharge roller 31 is located so as to come into contact with the medium M1 from above. The lower discharge roller 32 is located so as to come into contact with the medium M1 from below. The upper discharge roller 31 and the lower discharge roller 32 face each other.

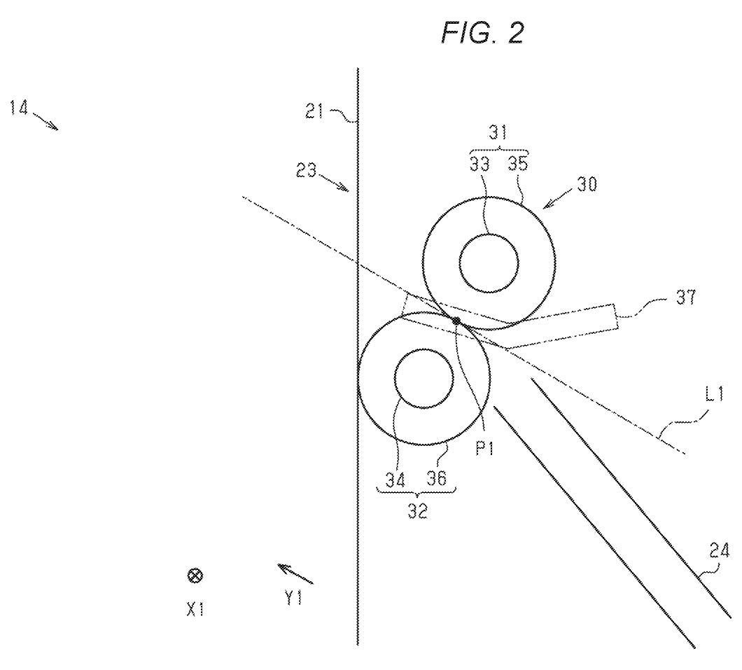

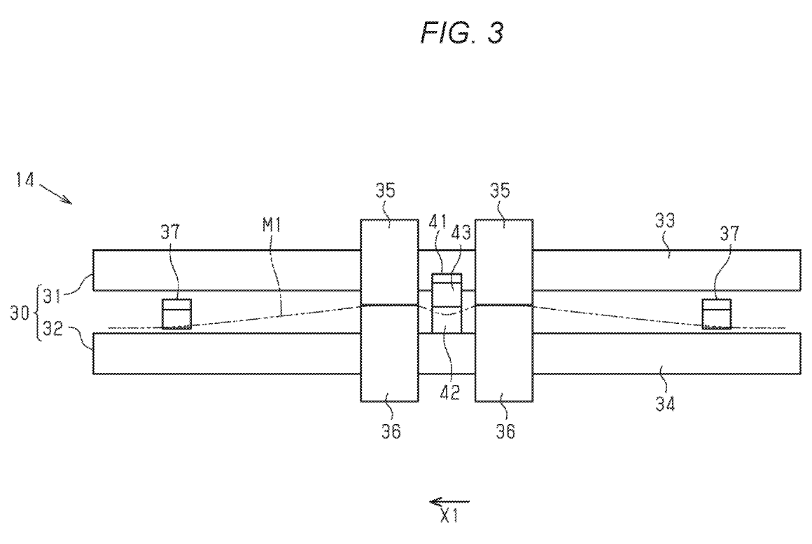

The discharge rollers each have a discharge shaft, as shown in FIGS. 2 and 3. The upper discharge roller 31 includes an upper discharge shaft 33. The lower discharge roller 32 includes a lower discharge shaft 34. The discharge shafts extend in an axial direction X1. In an example, the axial direction X1 is an index indicating the width of the medium M1. The upper discharge shaft 33 and the lower discharge shaft 34 are parallel to each other.

The discharge rollers each include one or more roller bodies. The upper discharge roller 31 includes one or more upper roller bodies 35. The lower discharge roller 32 includes one or more lower roller bodies 36. In an example, the upper discharge roller 31 includes two upper roller bodies 35. The lower discharge roller 32 includes two lower roller bodies 36.

The roller bodies are each supported by the discharge shaft. The multiple roller bodies may be located with a gap therebetween along the discharge shaft. The multiple roller bodies may be located symmetrically with respect to the center position of the discharge shaft in the axial direction X1. The upper roller bodies 35 are supported by the upper discharge shaft 33. The two upper roller bodies 35 are located symmetrically with respect to the center position of the upper discharge shaft 33 in the axial direction X1. The lower roller bodies 36 are supported by the lower discharge shaft 34. The two lower roller bodies 36 are located symmetrically with respect to the center position of the lower discharge shaft 34 in the axial direction X1.

The upper roller bodies 35 and the lower roller bodies 36 are located so as to face each other. In an example, the two upper roller bodies 35 and the two lower roller bodies 36 are located so as to face each other. The upper roller bodies 35 and the lower roller bodies 36 are located so as to nip the medium M1.

The discharge roller pair 30 nips the medium M1 at a nip position P1. The nip position P1 is the position where the upper discharge roller 31 and the lower discharge roller 32 are in contact with each other. In detail, the nip position P1 is the position where the upper roller bodies 35 and the lower roller bodies 36 are in contact with each other when viewed in the axial direction X1.

The discharge roller pair 30 discharges the medium M1 in a discharge direction Y1. The discharge direction Y1 is a direction different from the axial direction X1. The discharge direction Y1 is a direction in which a tangent L1, which is a tangent to the discharge roller pair 30 at the nip position P1, extends. The tangent L1 is an imaginary line perpendicular to a line segment that couples the axial center of the upper discharge roller 31 and the axial center of the lower discharge roller 32 to each other.

The medium discharging apparatus 14 may include one or more stiffening members 37. In an example, the medium discharging apparatus 14 includes two stiffening members 37. The stiffening members 37 are located at the discharge port 23. The stiffening members 37 are configured to come into contact with the medium M1 discharged by the discharge roller pair 30. The stiffening members 37 come into contact with the medium M1 in the course of the discharge performed by the discharge roller pair 30. The medium M1 is discharged via the discharge port 23 by the discharge roller pair 30 while being in contact with the stiffening members 37.

The stiffening members 37 are configured to stiffen the medium M1. That is, the stiffening members 37 come into contact with the medium M1 in a way to form a wave shape in the medium M1. In detail, the stiffening members 37 come into contact with the medium M1 in a way that the medium M1 has a wavy shape when the discharge port 23 is viewed from the front. Since the stiffening members 37 stiffen the medium M1, a concern that the medium M1 hangs down during the discharge is reduced. The medium M1 is thus appropriately discharged to the discharge tray 26.

The stiffening members 37 may be located so as to come into contact with the medium M1 before the medium M1 reaches the nip position P1. The stiffening members 37 may be located so as to come into contact with the medium M1 after the medium M1 reaches the nip position P1. For example, the stiffening members 37 extend so as to enter the gap between the upper discharge shaft 33 and the lower discharge shaft 34 from the side upstream of the discharge roller pair 30.

The stiffening members 37 may be located so as to come into contact with the medium M1 from above. The stiffening members 37 may come into contact with the medium M1 so as to push the medium M1 downward to a position below the nip position P1. The medium M1 thus has a wavy shape having upward convex portions in contact with the roller bodies. The stiffening members 37 may come into contact with the medium M1 so as to push the medium M1 upward to a position above the nip position P1.

The two stiffening members 37 may be located symmetrically with respect to the center position of the discharge shafts in the axial direction X1. In an example, the two stiffening members 37 are located in regions outside the region sandwiched between the two roller bodies in the axial direction X1. The two stiffening members 37 are located so as to come into contact, for example, with opposite end portions of the medium M1. In an example, the two stiffening members 37 displace the opposite end portions of the medium M1 downward.

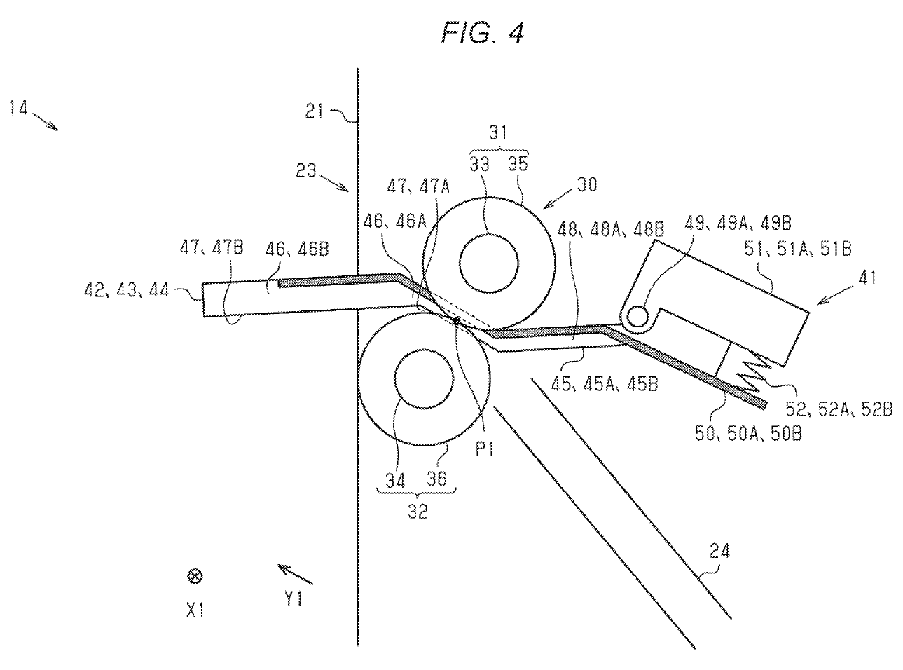

The medium discharging apparatus 14 includes one or more lever units 41, as shown in FIGS. 3 and 4. The lever unit 41 is attached to the enclosure 21. The lever unit 41 is located at the discharge port 23. The lever unit 41 is configured to come into contact with the medium M1. The lever unit 41 is configured to come into contact with the medium M1 discharged by the discharge roller pair 30. The lever unit 41 comes into contact with the medium M1 in the course of the discharge performed by the discharge roller pair 30. The medium M1 is discharged via the discharge port 23 by the discharge roller pair 30 while being in contact with the lever unit 41.

The lever unit 41 includes one or more lever bodies 42. In an example, the lever unit 41 includes one lever body 42. The lever body 42 is a body portion of the lever unit 41. The lever body 42 is configured to come into contact with the medium M1. The lever body 42 comes into contact with the medium M1 discharged by the discharge roller pair 30. The lever body 42 is configured to rotate relative to the enclosure 21. The lever body 42 is displaced when it rotates. The lever body 42 is displaced, for example, as the medium M1 comes into contact therewith.

The lever unit 41 includes a stiffening lever 43. The stiffening lever 43 is configured with the lever body 42. The stiffening lever 43 is configured to stiffen the medium M1. The stiffening lever 43 comes into contact with the medium M1 to stiffen the medium M1. The stiffening lever 43 comes into contact with the medium M1 in a way to form a wave shape in the medium M1, as the stiffening members 37.

The stiffening lever 43 may be located so as to come into contact with the medium M1 before the medium M1 reaches the nip position P1. The stiffening lever 43 may be located so as to come into contact with the medium M1 after the medium M1 reaches the nip position P1. For example, the stiffening lever 43 extends so as to enter the gap between the upper discharge shaft 33 and the lower discharge shaft 34 from the side upstream of the discharge roller pair 30. The stiffening lever 43 extends so as to close the nip position P1. That is, a portion of the stiffening lever 43 overlaps with the nip position P1 in a side view. The stiffening lever 43 thus reliably comes into contact with the medium M1 discharged by the discharge roller pair 30.

The stiffening lever 43 may be located so as to come into contact with the medium M1 from above. The stiffening lever 43 may come into contact with the medium M1 so as to push the medium M1 downward to a position below the nip position P1. The medium M1 thus has a wavy shape having upward convex portions in contact with the roller bodies. In an example, the stiffening lever 43 is located so as to come into contact with the medium M1 from above at the nip position P1. The stiffening lever 43 may come into contact with the medium M1 so as to push the medium M1 upward to a position above the nip position P1.

The stiffening lever 43 is located between the two roller bodies in the axial direction X1. The stiffening lever 43 is located between the two upper roller bodies 35 in the axial direction X1. The stiffening lever 43 is located between the two lower roller bodies 36 in the axial direction X1. The stiffening lever 43 is located so as to come into contact, for example with a central portion of the medium M1. In an example, the stiffening lever 43 displaces the central portion of the medium M1 downward.

The lever unit 41 includes a suppression lever 44. The suppression lever 44 is configured with the lever body 42. The suppression lever 44 is configured to suppress the ejection speed of the medium M1 when the medium M1 is ejected via the discharge port 23. The suppression lever 44 comes into contact with the medium M1 to suppress the ejection speed of the medium M1. The medium M1 may gain momentum and may be forcefully discharged via the discharge port 23 by the discharge roller pair 30. In this case, there is a concern that the medium M1 is not appropriately discharged to the discharge tray 26. For example, the medium M1 may not be aligned with the discharge tray 26, or the medium M1 may fall off the discharge tray 26. The suppression lever 44 suppresses the ejection speed of the medium M1, so that the medium M1 is appropriately discharged to the discharge tray 26.

The suppression lever 44 is located so as to come into contact with the medium M1 downstream of the stiffening lever 43 in the discharge direction Y1. That is, the suppression lever 44 is located so as to come into contact with the medium M1 after the stiffening lever 43 comes into contact therewith. The suppression lever 44 is located so as to come into contact with the medium M1 having been stiffened by the stiffening lever 43.

The suppression lever 44 comes into contact with the medium M1 so as to cause the medium M1 to fall toward the discharge tray 26. The suppression lever 44 comes into contact with the medium M1 from above to cause the medium M1 to fall onto the discharge tray 26.

The suppression lever 44 is located so as to come into contact with the medium M1 after the medium M1 reaches the nip position P1. For example, the suppression lever 44 extends so as to enter the gap between the upper discharge shaft 33 and the lower discharge shaft 34 from the side upstream of the discharge roller pair 30 in the discharge direction Y1.

The suppression lever 44 is located so as to come into contact with the medium M1 from above. The suppression lever 44 comes into contact with the medium M1 so as to knock off the medium M1 having passed through the nip position P1. The medium M1 thus falls toward the discharge tray 26.

The suppression lever 44 is located in a region sandwiched between the two roller bodies in the axial direction X1. The suppression lever 44 is located between the two upper roller bodies 35 in the axial direction X1. The suppression lever 44 is located between the two lower roller bodies 36 in the axial direction X1. The suppression lever 44 is located so as to come into contact, for example with a central portion of the medium M1.

The stiffening lever 43 and the suppression lever 44 may be configured to operate in conjunction with each other. The stiffening lever 43 and the suppression lever 44 may be integrated into a single unit. The stiffening lever 43 and the suppression lever 44 may be configured, for example, to rotate as an integral unit. The stiffening lever 43 and the suppression lever 44 may be configured independently of each other.

The stiffening lever 43 and the suppression lever 44 are configured with one lever body 42. That is, the lever unit 41 includes one lever body 42 into which the stiffening lever 43 and the suppression lever 44 are integrated. The stiffening lever 43 and the suppression lever 44 are thus integrated into a single unit. The stiffening lever 43 and the suppression lever 44 may be configured with separate lever bodies 42. That is, the lever unit 41 may include a lever body 42 that constitutes the stiffening lever 43 and a lever body 42 that constitutes the suppression lever 44.

The lever body 42 extends from the side upstream of the discharge roller pair 30 toward the side downstream of the discharge roller pair 30 in the discharge direction Y1. The lever body 42 is located between the two roller bodies in the axial direction X1.

The lever body 42 includes a body member 45. That is, the stiffening lever 43 and the suppression lever 44 each have the body member 45. In detail, the stiffening lever 43 includes a stiffening body member 45A. The suppression lever 44 includes a suppression body member 45B. In an example, the stiffening body member 45A and the suppression body member 45B are integrated into a single unit. The body member 45 is made, for example, of a resin material.

The body member 45 includes a contact portion 46. That is, the stiffening body member 45A and the suppression body member 45B each have the contact portion 46. In detail, the stiffening body member 45A has a stiffening contact portion 46A. The suppression body member 45B has a suppression contact portion 46B. In an example, the body member 45 has the stiffening contact portion 46A and the suppression contact portion 46B.

The contact portion 46 is a portion that comes into contact with the medium M1. In an example, the contact portion 46 comes into contact with the medium M1 from above. The stiffening contact portion 46A comes into contact with the medium M1 to stiffen the medium M1. The suppression contact portion 46B comes into contact with the medium M1 to suppress the ejection speed of the medium M1.

The stiffening contact portion 46A and the suppression contact portion 46B are linked to each other in the body member 45. In the body member 45, the suppression contact portion 46B extends from the stiffening contact portion 46A in the discharge direction Y1. Therefore, in the body member 45, the suppression contact portion 46B is located downstream of the stiffening contact portion 46A in the discharge direction Y1. The stiffening contact portion 46A is a portion located in the middle of the body member 45. The suppression contact portion 46B is a portion located at the tip of the body member 45.

The contact portion 46 has a contact surface 47. That is, the stiffening contact portion 46A and the suppression contact portion 46B each have the contact surface 47. In detail, the stiffening contact portion 46A has a stiffening contact surface 47A. The suppression contact portion 46B has a suppression contact surface 47B.

The contact surface 47 is a surface of the contact portion 46 that is the surface that comes into contact with the medium M1. The contact surface 47 is a surface of the contact portion 46 that is the surface facing downward. The stiffening contact surface 47A extends so as to close the nip position P1. A portion of the stiffening contact surface 47A is located below the nip position P1. The medium M1 therefore readily comes into contact with the stiffening contact surface 47A. The stiffening contact surface 47A may extend parallel to the tangent L1. In detail, the stiffening lever 43 may be maintained at a position where the stiffening contact surface 47A is parallel to the tangent L1. The suppression contact surface 47B is linked to the stiffening contact surface 47A.

The body member 45 includes a support portion 48. That is, the stiffening body member 45A and the suppression body member 45B each include the support portion 48. In detail, the stiffening body member 45A includes a stiffening support portion 48A. The suppression body member 45B includes a suppression support portion 48B. In an example, the stiffening support portion 48A and the suppression support portion 48B are integrated into a single unit.

The support portion 48 is a portion that supports the contact portion 46. The support portion 48 is linked to the contact portion 46. The stiffening support portion 48A supports the stiffening contact portion 46A. The suppression support portion 48B supports the suppression contact portion 46B. In an example, the stiffening contact portion 46A is linked to the support portion 48. The suppression contact portion 46B is linked to the support portion 48 via the stiffening contact portion 46A. The support portion 48 is a portion located at the base end of the body member 45.

The lever body 42 includes a rotary shaft 49. That is, the stiffening lever 43 and the suppression lever 44 each include the rotary shaft 49. In detail, the stiffening lever 43 includes a stiffening rotary shaft 49A. The suppression lever 44 includes a suppression rotary shaft 49B. In an example, the stiffening rotary shaft 49A and the suppression rotary shaft 49B are integrated into a single unit.

The rotary shaft 49 is a shaft serving as the center of rotation of the body member 45. That is, the stiffening body member 45A rotates around the stiffening rotary shaft 49A. The suppression body member 45B rotates around the suppression rotary shaft 49B.

The rotary shaft 49 is located at the support portion 48. The body member 45 therefore rotates with the support portion 48 being a fulcrum. The body member 45 rotates with the support portion 48 being a fulcrum to displace the contact portion 46. That is, the stiffening body member 45A rotates with the stiffening support portion 48A being a fulcrum to displace the stiffening contact portion 46A. The suppression body member 45B rotates with the suppression support portion 48B being a fulcrum to displace the suppression contact portion 46B.

The rotary shaft 49 is located at a base end portion of the body member 45. The body member 45 therefore rotates due to its own weight in a way that the tip thereof is displaced downward. That is, the body member 45 rotates due to its own weight in a way that the contact portion 46 is displaced downward. In an example, the body member 45 rotates due to its own weight in a way that the stiffening contact portion 46A and the suppression contact portion 46B are displaced downward. The body member 45 thus comes into contact with the medium M1 from above.

The lever body 42 may include a reinforcing member 50. That is, the stiffening lever 43 and the suppression lever 44 may each include the reinforcing member 50. In detail, the stiffening lever 43 may include a stiffening reinforcing member 50A. The suppression lever 44 may include a suppression reinforcing member 50B. In an example, the stiffening reinforcing member 50A and the suppression reinforcing member 50B are integrated into a single unit.

The reinforcing member 50 is a member that reinforces the body member 45. The reinforcing member 50 is made, for example, of sheet metal. The reinforcing member 50 is attached to an upper portion of the body member 45. The reinforcing member 50 extends along the body member 45. The reinforcing member 50 extends, for example, from the contact portion 46 to the support portion 48.

The lever body 42 may include a holder 51. That is, the stiffening lever 43 and the suppression lever 44 may each include the holder 51. In detail, the stiffening lever 43 may include a stiffening holder 51A. The suppression lever 44 may include a suppression holder 51B. In an example, the stiffening holder 51A and the suppression holder 51B are integrated into a single unit.

The holder 51 is a member that holds the body member 45. The holder 51 holds the body member 45 in a rotatable manner. The holder 51 holds the body member 45 by supporting the rotary shaft 49. The holder 51 is attached to the enclosure 21.

The lever body 42 may include an elastic member 52. That is, the stiffening lever 43 and the suppression lever 44 may each include the elastic member 52. In detail, the stiffening lever 43 may include a stiffening elastic member 52A. The suppression lever 44 may include a suppression elastic member 52B. In an example, the stiffening elastic member 52A and the suppression elastic member 52B are integrated into a single unit. The elastic member 52 is a member having elasticity. The elastic member 52 is, for example, a coil spring.

The elastic member 52 supports the body member 45 in a way that the body member 45 hangs down relative to the enclosure 21. The elastic member 52 supports the body member 45 in a way that the body member 45 hangs down relative to the holder 51. The elastic member 52 is attached to the holder 51. The elastic member 52 is attached to the reinforcing member 50. The elastic member 52 may be attached to the body member 45 instead of the reinforcing member 50.

The elastic member 52 supports the body member 45 in a way that the body member 45 is maintained at a contact position. The contact position is the position where the contact portion 46 comes into contact with the medium M1. That is, the contact position is a position on the stiffening lever 43 where the stiffening contact portion 46A stiffens the medium M1. The contact position is a position on the suppression lever 44 where the suppression contact portion 46B suppresses ejection of the medium M1. In an example, the contact position is the position on the body member 45 where the stiffening contact portion 46A stiffens the medium M1 and the suppression contact portion 46B suppresses the speed at which the medium M1 is ejected via the discharge port 23. The body member 45 shown in FIG. 4 is located at the contact position.

The elastic member 52 supports the body member 45 against the rotation of the body member 45 due to its own weight. The elastic member 52 is located upstream of the rotary shaft 49 in the discharge direction Y1. The elastic member 52 is attached to a base end portion of the reinforcing member 50. A tip portion of the reinforcing member 50 is a portion along the suppression contact portion 46B. The elastic member 52 is therefore compressed by the rotation of the body member 45 due to its own weight. The elastic member 52 operates against the compression to maintain the body member 45 at the contact position.

The elastic member 52 presses the contact portion 46 to displace it downward. In detail, when the contact portion 46 is displaced upward, the elastic member 52 presses the contact portion 46 to displace it downward. In an example, when the contact portion 46 is displaced upward, the elastic member 52 is pulled by the holder 51 and the reinforcing member 50. The elastic member 52 contracts against the tensile force to press the contact portion 46 to displace it downward. The stiffening elastic member 52A presses the stiffening contact portion 46A to displace it downward. The suppression elastic member 52B presses the suppression contact portion 46B to displace it downward.

### Operation of Lever Unit

The operation of the lever unit 41 will next be described.

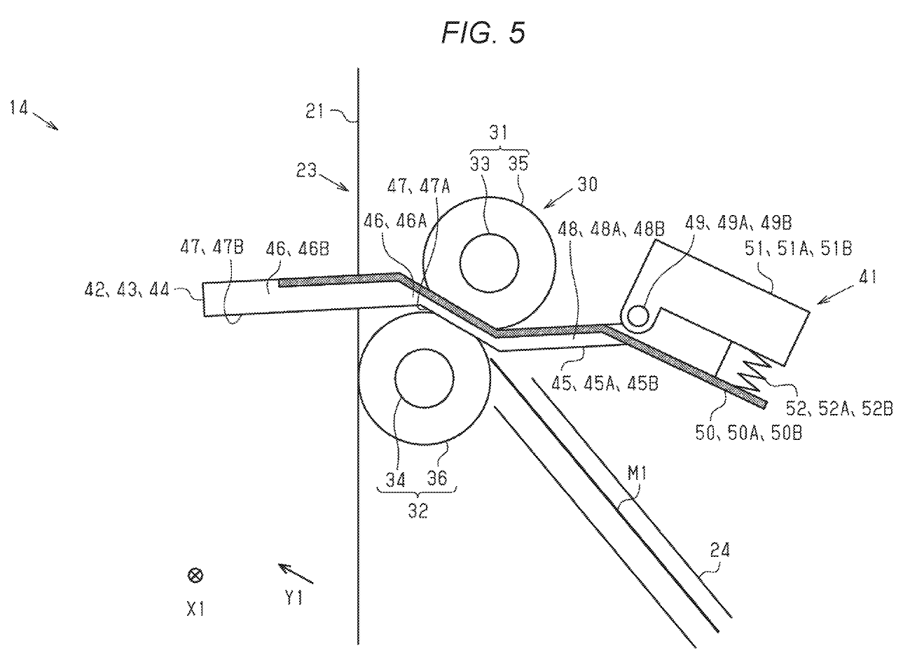

When the medium M1 is conveyed by the conveyer 27, the tip of the medium M1 reaches the discharge roller pair 30, as shown in FIG. 5. At this point in time, the body member 45 is located at the contact position. The tip of the medium M1 therefore comes into contact with the stiffening contact portion 46A before reaching the nip position P1. The medium M1 is therefore discharged by the discharge roller pair 30 with the medium M1 having been stiffened by the stiffening contact portion 46A.

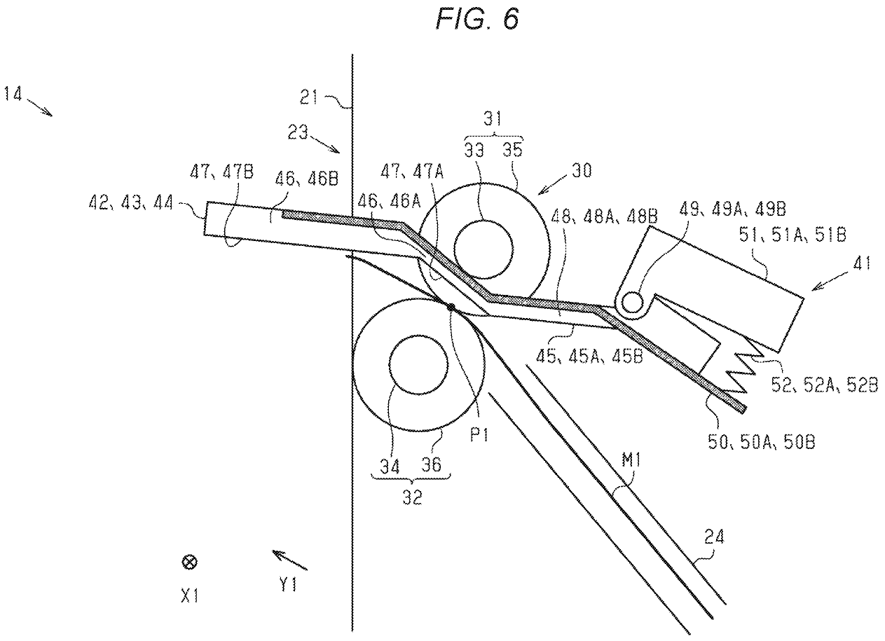

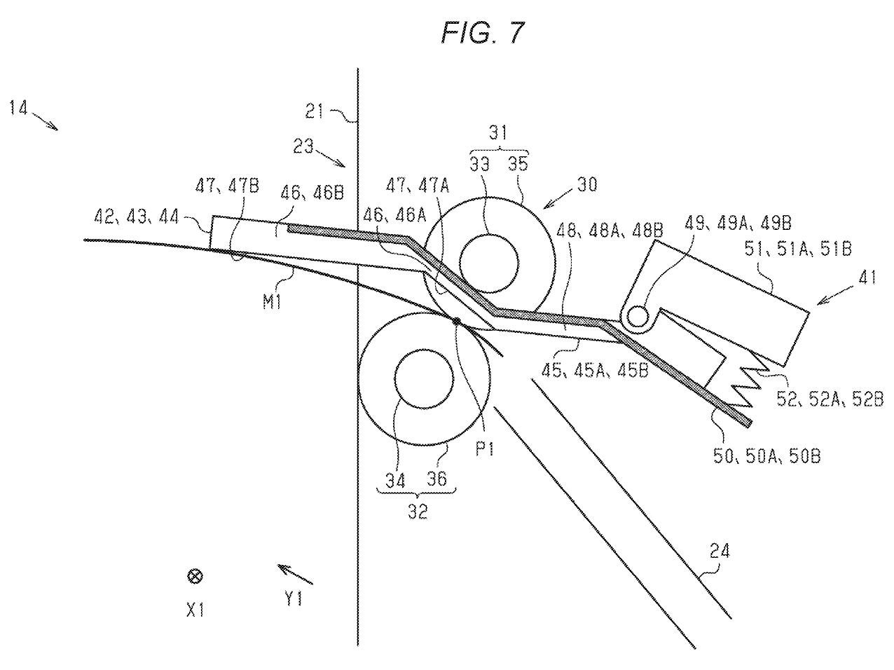

As the medium M1 is discharged by the discharge roller pair 30, the medium M1 comes into contact with the suppression contact portion 46B, as shown in FIGS. 6 and 7. The discharge roller pair 30 discharges the medium M1 in a way that the medium M1 pushes the suppression contact portion 46B upward. The suppression lever 44 thus rotates in a way that the suppression contact portion 46B is displaced upward. At this point in time, since the distance between the holder 51 and the reinforcing member 50 increases, the elastic member 52 is pulled. The upward displacement of the suppression lever 44 reduces a concern that the suppression lever 44 hinders the discharge of the medium M1.

When the stiffening lever 43 is integrated with the suppression lever 44, following the upward displacement of the suppression contact portion 46B, the stiffening contact portion 46A is also displaced upward. At this point in time, the stiffening contact portion 46A may be separate from the medium M1 or may remain in contact with the medium M1. That is, following the upward displacement of the suppression contact portion 46B, the stiffening contact portion 46A may be displaced upward above the nip position P1 or may be maintained at or below the nip position P1. In an example, the stiffening contact portion 46A separates from the medium M1 following the upward displacement of the suppression contact portion 46B, but the stiffened medium M1 is maintained by the stiffening member 37.

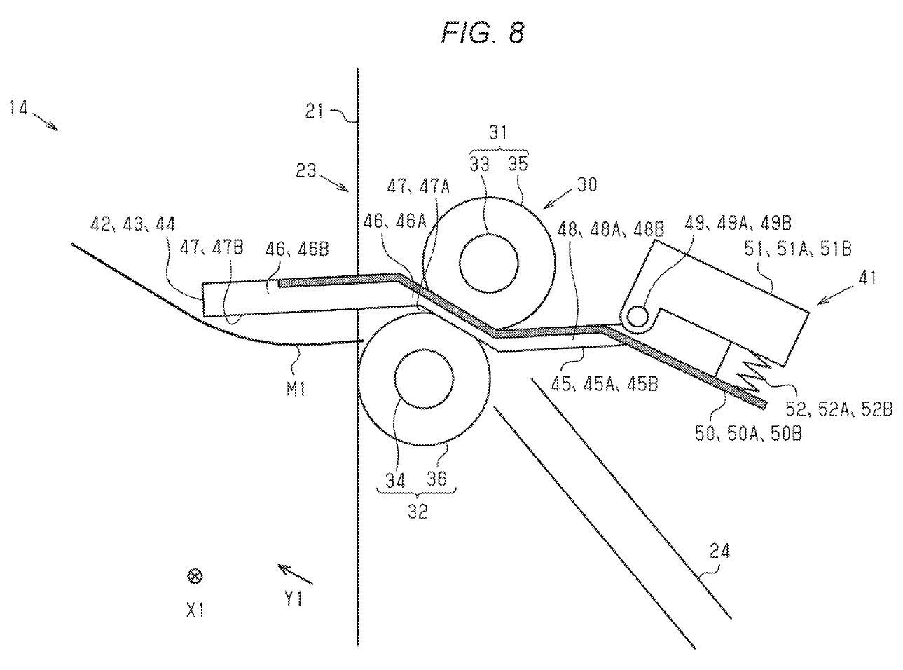

When the rear end of the medium M1 passes through the nip position P1, the suppression lever 44 returns to the contact position, as shown in FIG. 8. That is, the suppression lever 44 rotates in a way that the suppression contact portion 46B is displaced downward. When the suppression contact portion 46B is displaced downward, the medium M1 is knocked off by the suppression contact portion 46B. The medium M1 thus quickly falls toward the discharge tray 26. In an example, since the suppression lever 44 returns to the contact position due to the weight of the body member 45 and the elastic force of the elastic member 52, the medium M1 can be knocked off more quickly. Since the suppression lever 44 automatically operates along with the discharge of the medium M1 as described above, the power consumed by the medium discharging apparatus 14 is reduced as compared with a case where the suppression lever 44 operates with the aid of electric power.

In addition, acceleration/deceleration control of the discharge roller pair 30 is unnecessary. That is, to ensure that the media M1 are aligned with each other on the discharge tray 26, it is conceivable to employ a configuration in which the speed of the roller surfaces of the discharge roller pair 30 is reduced from a relatively high predetermined speed in the course of the discharge of the medium M1 via the discharge port 23. In this case, however, the load applied to the motor tends to increase, so that the power consumption tends to increase. In contrast, the present example allows reduction in the discharge speed of the medium M1 discharged via the discharge port 23 with the driving speed of the discharge roller pair 30 maintained constant. The power consumption is thus reduced.

### Effects of and Advantages of Embodiment

Effects of and advantages of the embodiment described above will next be described.

(1) The lever unit 41 includes the stiffening lever 43, which comes into contact with the medium M1 discharged by the discharge roller pair 30 to stiffen the medium M1. The lever unit 41 includes the suppression lever 44, which comes into contact with the medium M1 downstream of the stiffening lever 43 in the discharge direction Y1 to cause the medium M1 to fall toward the discharge tray 26. The configuration described above, in which the suppression lever 44 comes into contact with the medium M1, reduces a concern that the medium M1 having gained momentum is forcefully discharged. The medium M1 is thus appropriately discharged to the discharge tray 26. That is, the alignment of the media M1 at the discharge tray 26 can be improved.

(2) The stiffening lever 43 comes into contact with the medium M1 from above at the nip position P1. The suppression lever 44 is configured to rotate with the support portion 48 being a fulcrum to displace the suppression contact portion 46B. The configuration described above, in which the suppression lever 44 rotates with the support portion 48 being a fulcrum, reduces the concern that the suppression lever 44 hinders the discharge of the medium M1. For example, when the medium M1 is nipped by the discharge roller pair 30, the suppression contact portion 46B is displaced upward to allow smooth discharge of the medium M1. After the medium M1 passes through the discharge roller pair 30, the suppression contact portion 46B is displaced downward to cause the medium M1 to fall toward the discharge tray 26.

(3) The stiffening lever 43 is integrated with the suppression lever 44 and rotates with the support portion 48 being a fulcrum to displace the stiffening contact portion 46A. According to the configuration described above, since the stiffening lever 43 operates in conjunction with the suppression lever 44, the suppression contact portion 46B is displaced upward as the medium M1 comes into contact with the stiffening contact portion 46A. The suppression lever 44 is therefore automatically retracted, so that the concern that the suppression lever 44 hinders the discharge of the medium M1 is reduced.

(4) The stiffening contact portion 46A has the contact surface 47, which comes into contact with the medium M1. According to the configuration described above, the medium M1 is unlikely to be damaged as compared with a case where the stiffening contact portion 46A comes into point contact with the medium M1.

(5) The suppression lever 44 includes the rotary shaft 49, which is located at the support portion 48, and the elastic member 52, which presses the suppression contact portion 46B to displace it downward. According to the configuration described above, the suppression contact portion 46B is quickly displaced downward by the elastic member 52, so that the medium M1 is allowed to quickly fall to the discharge tray 26.

(6) The lever unit 41 is located between the two upper roller bodies 35 in the axial direction X1. According to the configuration described above, the lever unit 41 can effectively stiffen the medium M1.

### Variations

The embodiment described above may be modified as will be described below. The embodiment described above and the following variations may be implemented in combination to the extent that no technical contradictions occur.

The suppression lever 44 may include a plate spring member. In this case, the suppression contact portion 46B is configured with the plate spring member, and the suppression lever 44 includes a support member that supports the suppression contact portion 46B. The suppression contact portion 46B can thus be displaced with the support member being a fulcrum. The function of the suppression lever 44 can thus be realized with the simple configuration.

The stiffening members 37 may each be configured with a lever, as the stiffening lever 43. In this case, the stiffening members 37 can press the medium M1 in accordance with the rigidity of the medium M1. A concern that the medium M1 is damaged due to the contact with the stiffening members 37 is thus reduced.

The medium discharging apparatus 14 may include the lever unit 41 in place of the stiffening members 37. For example, the medium discharging apparatus 14 may include multiple lever units 41 located at intervals in the axial direction X1.

### Technical Ideas

Technical ideas figured out from the embodiment and the variations described above, and effects and advantages thereof will be described below.

(A) A medium discharging apparatus includes: a discharge roller pair configured to discharge a medium; a lever unit configured to come into contact with the medium discharged by the discharge roller pair; and a discharge tray configured to receive the medium discharged by the discharge roller pair, and the lever unit includes a stiffening lever configured to come into contact with the medium discharged by the discharge roller pair to stiffen the medium, and a suppression lever configured to come into contact with the medium at a position downstream of the stiffening lever in a direction in which the medium is discharged by the discharge roller pair to cause the medium to fall toward the discharge tray. The configuration described above, in which the suppression lever comes into contact with the medium, reduces the concern that the medium having gained momentum is forcefully discharged. The medium is thus appropriately discharged to the discharge tray.

(B) In the medium discharging apparatus described above, the stiffening lever may be configured to come into contact with the medium from above at a nip position where the medium is nipped by the discharge roller pair, the suppression lever may include a suppression contact portion configured to come into contact with the medium from above, and a support portion configured to support the suppression contact portion, and the suppression lever may be configured to rotate with the support portion being a fulcrum to displace the suppression contact portion. The configuration described above, in which the suppression lever rotates with the support portion being a fulcrum, reduces the concern that the suppression lever hinders the discharge of the medium. For example, when the medium is nipped by the discharge roller pair, the suppression contact portion is displaced upward to allow smooth discharge of the medium. After the medium passes through the discharge roller pair, the suppression contact portion is displaced downward to cause the medium to fall toward the discharge tray.

(C) In the medium discharging apparatus, the stiffening lever and the suppression lever may be integrated into a single unit, the stiffening lever may include a stiffening contact portion supported by the support portion and configured to come into contact with the medium from above, and the stiffening lever may be configured to rotate with the support portion being a fulcrum to displace the stiffening contact portion. According to the configuration described above, since the stiffening lever operates in conjunction with the suppression lever, the suppression contact portion is displaced upward as the medium comes into contact with the stiffening contact portion. The suppression lever is therefore automatically retracted, so that the concern that the suppression lever hinders the discharge of the medium is reduced.

(D) In the medium discharging apparatus described above, the stiffening contact portion may have a contact surface configured to come into contact with the medium. According to the configuration described above, the medium is unlikely to be damaged as compared with a case where the stiffening contact portion comes into point contact with the medium.

(E) In the medium discharging apparatus described above, the suppression lever may include a rotary shaft located at the support portion, and an elastic member configured to press the suppression contact portion to displace the suppression contact portion downward. According to the configuration described above, the suppression contact portion is quickly displaced downward by the elastic member, so that the medium is allowed to quickly fall to the discharge tray.

(F) In the medium discharging apparatus described above, the discharge roller pair may include an upper discharge roller configured to come into contact with the medium from above, and a lower discharge roller configured to come into contact with the medium from below, the upper discharge roller may include two upper roller bodies located with a gap therebetween in an axial direction, the lower discharge roller may include two lower roller bodies located with a gap therebetween in the axial direction, the two upper roller bodies and the two lower roller bodies may face each other, and the lever unit may be located between the two upper roller bodies in the axial direction. According to the configuration described above, the lever unit can effectively stiffen the medium.

(G) An image reading apparatus includes a reader configured to read an image on a medium; and the medium discharging apparatus described above. The configuration described above provides the same advantages as those provided by the medium discharging apparatus described above.

What is claimed is:

1. A medium discharging apparatus comprising:
a discharge roller pair configured to discharge a medium;
a lever unit configured to come into contact with the medium discharged by the discharge roller pair; and
a discharge tray configured to receive the medium discharged by the discharge roller pair,
wherein the lever unit includes
a stiffening lever configured to come into contact with the medium discharged by the discharge roller pair to stiffen the medium, and
a suppression lever configured to come into contact with the medium at a position downstream of the stiffening lever in a direction in which the medium is discharged by the discharge roller pair to cause the medium to fall toward the discharge tray.

2. The medium discharging apparatus according to claim 1, wherein
the stiffening lever is configured to come into contact with the medium from above at a nip position where the medium is nipped by the discharge roller pair, the suppression lever includes
a suppression contact portion configured to come into contact with the medium from above, and
a support portion configured to support the suppression contact portion, and
the suppression lever is configured to rotate with the support portion being a fulcrum to displace the suppression contact portion.

3. The medium discharging apparatus according to claim 2, wherein
the stiffening lever and the suppression lever are integrated into a single unit,
the stiffening lever includes a stiffening contact portion supported by the support portion and configured to come into contact with the medium from above, and
the stiffening lever is configured to rotate with the support portion being a fulcrum to displace the stiffening contact portion.

4. The medium discharging apparatus according to claim 3, wherein
the stiffening contact portion has a contact surface configured to come into contact with the medium.

5. The medium discharging apparatus according to claim 4, wherein
the suppression lever includes
a rotary shaft located at the support portion, and
an elastic member configured to press the suppression contact portion to displace the suppression contact portion downward.

6. The medium discharging apparatus according to claim 1, wherein
the discharge roller pair includes
an upper discharge roller configured to come into contact with the medium from above, and
a lower discharge roller configured to come into contact with the medium from below,
the upper discharge roller includes two upper roller bodies located with a gap therebetween in an axial direction,
the lower discharge roller includes two lower roller bodies located with a gap therebetween in the axial direction,
the two upper roller bodies and the two lower roller bodies face each other, and
the lever unit is located between the two upper roller bodies in the axial direction.

7. An image reading apparatus comprising:
a reader configured to read an image on a medium; and
the medium discharging apparatus according to claim 1.
